(19) United States
(12) Patent Application Publication
(10) Pub. No.: US 2010/0115269 A1
(43) Pub. Date: May 6, 2010

(54) Revoking Malware in a Computing Device

(75) Inventors: Matthew Allen, Essex (GB); Craig Heath, Herts (GB); Andrew Harker, Herts (GB)

Correspondence Address: Saul Ewing LLP (Philadelphia), Attn: Patent Docket Clerk, 2 North Second St., Harrisburg, PA, 17101, US

(73) Assignee: Symbian Software Limited, London (GB)

(21) Appl. No.: 12/306,343

(22) PCT Filed: Jun. 26, 2007
(86) PCT No.: PCT/GB2007/002367

§ 371 Date: Jan. 15, 2010

(30) Foreign Application Priority Data
Jun. 29, 2006 (GB) GB 0612933.2

(51) Int. Cl. H04L 29/06; G06F 21/00

(52) U.S. Cl. 713/157

(57) ABSTRACT

A computing device is operated in a manner which provides improved checking to determine whether or not an authentication certificate for a software application being loaded onto the device has been revoked. In the case of trusted certificate chains that contain no revocation information, the device checks using an AuthorityInfoAccess extension (AIA) as selected by the device. In the case of untrusted certificate chains, notably including self-signed certificates, the device is controlled so that it ignores any authentication revocation information provided with the software application and always uses information stored on the device.

This invention relates to an improved method for revoking malware in a computing device and in particular, to an improved method for revoking malware by which computing devices can detect and avoid the installation of malicious or unsafe software.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of such devices, together with many other industrial and domestic electronic appliances.

A computing device that allows an owner or user to install software subsequent to purchase, which makes available new applications or provides new functionality, is termed an open device.

Though there are clear benefits to being able to extend the utility of a device in this way, this facility can represent a significant security risk for the owner or user. Those skilled in the art, as well as many who are not so skilled, are aware that there is a significant risk that either badly written or malicious programs (malware) can affect open computing devices. Where the computing device is connected to other devices over a network, this risk can extend to all other devices connected to the network, and can threaten the integrity of the network itself. There are many varieties of such malware; common types include, without limitation, viruses, trojans, spyware and adware.

There are many software packages that offer users detection, prevention and removal of the various types of malware on open computing devices; there is a multi-billion dollar market for anti-virus software. However, it is generally acknowledged by those skilled in the art that, wherever possible, it is better to avoid infection by malware in the first place.

One of the key disciplines in avoiding infection on any open computing device is to check any item of software that is to be installed by
a) authenticating its identity and ensuring that it originates from a trusted source known to provide bona-fide software and not malware, and
b) ensuring that the software has not been tampered with or infected by any type of malware between the time it leaves the trusted source and the time it reaches the end-user and is loaded onto the device.

One way in which tamper detection can be assured is by comparing a hash or digest of the package to be installed with a similar hash or digest published by a trusted author or distributor of a package. One standard method for providing this assurance, described in the Internet Standard RFC 1321, has been Ronald Rivest's MD5. Another set of standard methods are the SHA algorithms published by the US National Security Agency. However, the integrity of such methods depends on an assurance that the published hash being relied upon as valid is actually coming from a source which itself cannot be compromised.

An alternative method of detecting infection is to compare the hash of a package to a trusted list of hashes of packages that are known to be bad. However, this solution is unsatisfactory for a number of reasons:
it is essentially reactive rather than preventative
it is too easily circumvented, as it is a trivial matter for a malware writer to randomly change some trivial item of data to ensure that a different hash is computed; this makes it simple for a package to change its apparent identity and achieve an acceptable result when compared to the trusted list.

Consideration of the latter reason leads to the conclusion that for practical purposes, technologies for tamper-detection depend on authentication of identity to assure their integrity.

The most well-known techniques for authenticating and validating the integrity of an item of software rely on signing and certification using asymmetric or public key cryptography as a key element. The ITU-T X.509 standard for Public Key Infrastructure (PKI) is an example of such a scheme. A simplified implementation of this technology as applied to authentication of any item of installable software might work as follows:
1. A software application for a computing device that is to be made available to the public is compiled into a package which is in the first instance digitally signed by the author, developer or distributor; this embeds both their public key and a secure hash of the content. The author, developer or distributor then sends the package to a trusted party which is able to enact a Certification Authority (CA).
2. The CA re-signs the package to indicate that the first signatory of the package is someone who is trusted by them. Ideally, the software application should have been vetted, examined or checked by the CA to ensure that the software is neither badly written nor malicious. The re-signed package is then returned to the original author, developer or distributor, who is then able to distribute it to the public.
3. Computing devices able to take advantage of X.509 PKI schemes are provided with the digital certificate of the CA (a root certificate). This can be present in the firmware of the device or could be provided with a network-aware application such as a browser. When the user of a computing device asks its software installer to install the package, the installer inspects the embedded certificate in order to confirm the identity of the software and its author, and also to detect any tampering. Since the computing device already contains a root certificate, the installer refers to this to verify the identity and integrity of the package; and the software application can be installed on the computing device with a high degree of assurance that it is a bona fide application.

The chain of authentication used in X.509 PKI is typically longer than is explained in this example, but the principle remains the same; following a chain of signed certificates to eventually lead back to a trusted root certificate.

Not all signatures on packages conform to the hierarchical X.509 PKI scheme described above. One of the main reasons for this is that X.509 compliant certification is by no means a free process. The leading root signatory, Verisign, currently charges in excess of US $400 for each certificate it issues (see http://www.verisign.com/products-services/security-services/code-signing/digital-ids-code-signing/index.html) and this not insignificant sum of money is a barrier which can prevent many aspiring developers of software for open devices from participating in hierarchical PKI schemes. Certification schemes which check and vet submitted software generally need to make a charge to cover for what is a significant amount of work; for many schemes, it is not realistic economically for this to be done completely free of charge.

An alternative certification model relies on a Web of Trust, in which certificates are signed by multiple parties who require no special status to act as co-signatories. As long as at least one of the signatories is an entity who is known to and trusted by the user, they can use their copy of that signatory's public key to validate the certificate.

It is also possible for software packages to be self-signed by the author. While this cannot establish the same degree of confidence as signatures that can be verified by a PKI or Web of Trust, a self-signed certificate is by no means worthless; because it uses asymmetric cryptography, it still enables self-signed packages to be uniquely identified and provides therefore a relatively firm guarantee against third-party tampering.

In summary, then, signing with a digital certificate achieves the following three goals:
1. It is straightforward to identify a given package by means of its public key and serial number.
2. It is straightforward to identify whether the package is tamper-free by verifying the hash or digest included with the digital signature.
3. The presence of the signature means that it is not straightforward to make one package look like another without it being re-signed; and that can only be done by the possessor of the private key used to sign the original version.

However, for all technologies that rely on digital signatures and certification, it is nevertheless known that software packages can be signed in error. Some examples of vulnerabilities in the process include:
the trust placed by the CA or other intermediate signing authority in the originator of the package may have been misplaced.
the trust placed by the originator in one of their employees or agents may have been misplaced
one of the private keys in an X.509 chain may have been compromised; the longer the chain, the greater the risk
the package may turn out to have been previously unsuspected, but subsequent unexpected security flaws can make it vulnerable to exploitation by malware, which can cause the package to be withdrawn by its supplier.

Because certificates may have been erroneously granted, there are systems in place by which they can be revoked, and X.509 procedures exist by which any certificate may be checked to see whether it is in fact still valid.

The original X.509 standard required a Certificate Revocation List (CRL) to be downloaded for each signing authority in the authentication chain; this list contained an entry for all of the certificates that had been revoked. The Internet Standard RFC 1422 further defines the format of CRLs for use with Privacy-enhanced Electronic Mail (PEM).

A more recent standard method for allowing certificates to be checked for revocation is the Online Certificate Status Protocol (OCSP), defined in the Internet Standard RFC2560. OCSP allows entities wishing to validate certificates to do so by making a request of OSCP responders in order to find out the status of a single certificate. Among the benefits of this system are that long CRLs no longer need to be retrieved and studied. This leads to lower network overheads, and removes the need to parse an entire list to find out information on just one certificate.

Whatever revocation checking method is in use, it is necessary that the entity performing it should know either where to go to obtain the latest revocation lists in the case of CRL or what responder they need to contact when they want to make an OSCP request. A method for determining this information is supplied by Internet Standard, RFC3280, which defines standard X.509 Certificate Extensions for this purpose.

For CRL, the X.509 cRLDistributionPoints extension points at the correct location when retrieving CRLs, while for OSCP, the AuthorityInfoAccess extension (AIA) indicates to requestors which responder should be contacted to obtain information and services about the certificate issuer and make enquiries about possible revocation requests.

Entities will commonly make separate enquiries for each certificate in the chain using these fields, if present (though OSCP requests can be chained to other responders in some circumstances).

It is apparent from this description of the known methods that any open computing device can be made more secure by making signing and certification mandatory for all software packages that a user wishes to install. By this means, the identity of installable packages can be authenticated and the contents can, in essence, be verified to be tamper-free. Packages that subsequently turn out to be malware can be identified by means of their certificates, which can be revoked via the revocation infrastructures outlined above.

The verification method defined by X.509, by which a certificate includes the means of checking for its own revocation, can be circular.

The most obvious case of such circularity is for a software package that is self-signed by the author, creator or distributor and by nobody else. For the avoidance of doubt, it should be noted that for the purposes of the description of this invention, a certificate chain for such a package may have been provided; it just happens to consist of a single certificate.

While such packages fulfill the same goals as all other signed packages, in that they can be unambiguously identified and can be verified as tamper-free since they were signed, they cannot reliably be checked for revocation using information contained in the certificate extensions. The signatory of a malware package could all too easily use such an extension to direct anyone seeking to check the validity of the certificate to their own CRL or OSCP servers and responders, which would of course always return a favorable status report because they are controlled by the malware signatory.

Mechanisms such as CRL and OCSP are really only designed to work with certificates that can be traced back to a root certificate. Self-signed certificates can employ standard extensions which direct CRL or OCSP clients to their own server which would, of course, be designed to report the status of their own software favourably. Clearly, this (prior art) is only appropriate for issuer-signed certificates and new behaviour is required if self-signed certificates are to be admitted into the same scheme.

A method of extending certificate revocation technology on a computing device so as to work effectively with software packages that are self-signed is therefore required.

According to a first aspect of the present invention there is provided a method of operating a computing device enabled to make use of one or more sets of previously stored information to supplement, replace or override information concerning certificate revocation provided by a chain of one or more certificates included with a software package, the method comprising causing the computing device to utilise previously stored information concerning certificate revocation in the event that
a. the chain of certificates included with the software package resolve to a trusted certificate stored on the device; and
b. any of the certificates included with the software package do not include revocation information.

According to a second aspect of the present invention there is provided a computing device arranged to operate in accordance with a method of the first aspect.

According to a third aspect of the present invention there is provided an operating system for causing a computing device to operate in accordance with a method of the first aspect.

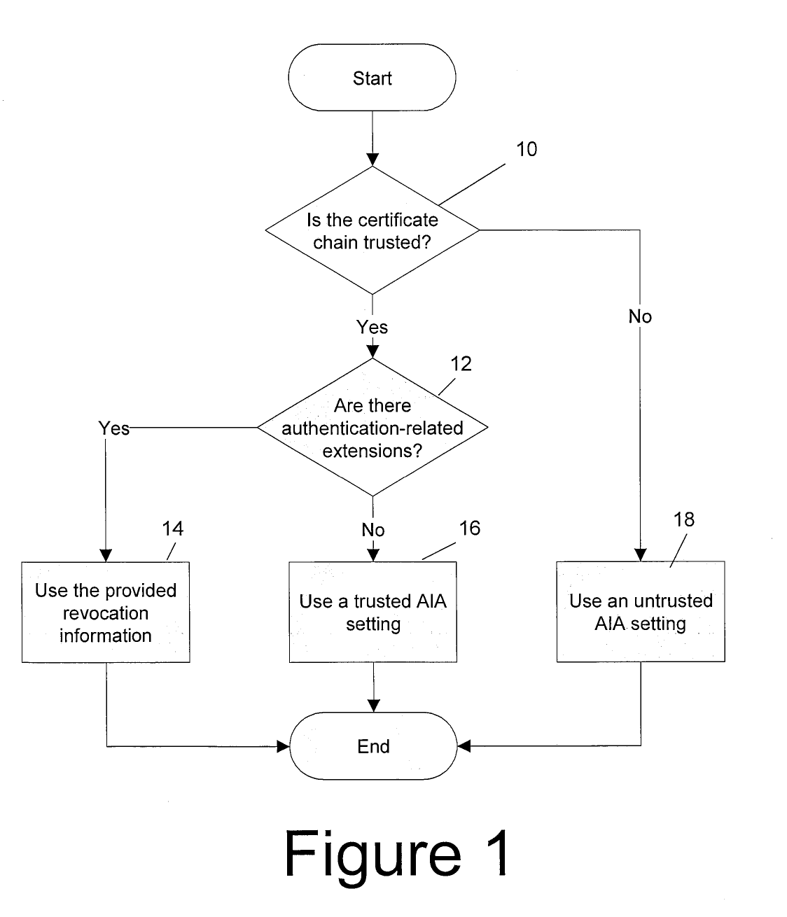

Embodiments of the present invention will now be described, by way of further example only, with reference to FIG. 1.

A preferred implementation of the present invention is shown in FIG. 1. In this implementation a CRL or OCSP client in the device checks for revocation using two different methods, the choice of which depends on which one of two conditions holds:
a. Is the certificate chain under examination trusted; does it resolve to a known root certificate or other trust anchor on the device?
b. Is the certificate chain under examination untrusted; does it not resolve to any known root certificate or other trust anchor on the device?

This is shown as step 10 in FIG. 1.

If condition (a) above is encountered, and authentication-related X.509 extensions (cRLDistributionPoints or AIA) are present, the CRL or OCSP client will accept and process any such extensions using the provided revocation information, as shown by steps 12 and 14 in FIG. 1. If no such extensions are present, the OCSP client in the device will use by preference a default trustedAIA setting and thereby contact an OSCP responder of its own choosing, shown as step 16 in FIG. 1.

If condition (b) above is encountered, the CRL or OCSP client ignores any authentication-related X.509 extensions (cRLDistributionPoints or AIA) given in the certificates present, and instead employs a default untrustedAIA setting, step 18 in FIG. 1, and thereby contacts an OSCP responder of its own choosing. This untrustedAIA setting contains a trusted list of certificates which are known to have been revoked.

Note that the trustedAIA setting and the untrustedAIA setting need not necessarily point at different OSCP responders: they may actually be the same OSCP responders.

However, an additional enhancement is possible if they point at different responders; any server fulfilling the role of an untrustedAIA server can be modified to return a good response for certificates which are unknown rather than return a response which may cause devices coded to reject transient errors to fail the OCSP validation check. The assumption behind this enhancement is that users and other parties involved with the distribution of software for particular classes of device must be and will be very diligent about reporting known cases of malware; but that they will and should not be under any corresponding obligation to submit notification for software that they believe to be benign.

While it is of course possible as an alternative to implement this invention via CRL using trustedcRLDistributionPoints and untrustedcRLDistributionPoints settings, it should be noted that this would be less efficient that the OSCP variants.

Many advantages accrue through the use of the present invention, including
Malware creators cannot clone signatures in the hope of having non-malware removed.
Changes to CRL/OCSP client behaviour allows self-signed certificates to be revoked through the standard scheme. Malware creators cannot encourage clients to go to certificate-specified servers in order to generate favourable responses.
Because self-signed certificates are essentially issuer-less, a server designed to handle arbitrary self-signed certificates can be specially modified to only return failures for certificates on its blacklist.
The scheme is applicable to any revocation domain.
For open devices, this revocation scheme potentially allows a wider range of software to be developed because self-signed certificates are effectively free.
The scheme still permits those who desire a higher level of security to refuse to install any software where the certification chain cannot be traced back to a trusted anchor (either X.509 or Web of Trust or both).

Although the present invention has been described with reference to particular embodiments, it will be appreciated that modifications may be effected whilst remaining within the scope of the present invention as defined by the appended claims.

1. A method of operating a computing device, the method comprising enabling the device to make use of one or more sets of previously stored information to supplement, replace or override information concerning certificate revocation provided by a chain of one or more certificates included with a software package, wherein the computing device is caused to utilise the previously stored information in the event that the chain of certificates included with the software package does not resolve to a trusted certificate previously stored on the device.

2. (canceled)

3. A method according to 1 wherein the previously stored information concerning certificate revocation differs from the previously stored information concerning certificate revocation utilised in the event that
a. the chain of certificates included with the software package resolves to a trusted certificate stored on the device; and
b. any of the certificates included with the software package do not include revocation information.

4. A method according to 1 wherein the previously stored information concerning certificate revocation is the previously stored information concerning certificate revocation utilised in the event that
a. the chain of certificates included with the software package resolve to a trusted certificate stored on the device; and
b. any of the certificates included with the software package do not include revocation information.

5. A method according to claim 1 wherein the chain of certificates included with the software package comprises X.509 certificates and wherein the information concerning certificate revocation is provided either by CRL or OSCP revocation related extensions.

6. A method according to claim 1 wherein the previously stored information on the computing device comprises
a. CRL related extensions such as cRLDistributionPoints for accessing CRL servers; and/or
b. OSCP revocation related extensions such as AuthorityInfoAccess for accessing OSCP responders or servers.

7. A method according to claim 6 wherein, when the previously stored information comprises CRL related extensions and OSCP revocation related extensions, the computing device is arranged to use the OSCP extensions in preference to the CRL extensions

8. A method according to claim 1 wherein the previously stored information utilised when the chain of certificates included with the software package does not resolve to a trusted certificate previously is used to access an OSCP responder or server for returning an affirmative response for unknown certificates.

9. A computing device arranged to operate in accordance with a method as claimed in claim 1.

10. An operating system for causing a computing device to operate in accordance with a method as claimed in claim 1.
